(19) United States
(12) Patent Application Publication
(10) Pub. No.: US 2025/0335457 A1
(43) Pub. Date: Oct. 30, 2025

(54) SYSTEM AND METHOD FOR BUILDING ADAPTIVE LIBRARY OF ENVIRONMENTAL SURVEILLANCE SPECTRAL DATA

(71) Applicant: Battelle Memorial Institute, Columbus, OH (US)

(72) Inventors: Jared M. SCHUETTER, Columbus, OH (US); Adam V. RICH, Columbus, OH (US); Michael R. RIEDL, Worthington, OH (US); Sanjay M. TAMRAKAR, HIlliard, OH (US); Christopher SCHEITLIN, Columbus, OH (US); Rodney S. BLACK, HIlliard, OH (US); Steven M. RISSER, Reynoldsburg, OH (US); Aaron M. DEAL, Troy, OH (US)

(21) Appl. No.: 19/194,115

(22) Filed: Apr. 30, 2025

Related U.S. Application Data
(60) Provisional application No. 63/640,378, filed on Apr. 30, 2024.

(51) Int. Cl. G06F 16/25; G01N 21/65

(52) U.S. Cl. CPC G06F 16/25; G01N 21/65

(57) ABSTRACT

In an approach to adaptive library building, a method includes: acquiring one or more spectra for particles from a source material using one or more environmental surveillance sensors; identifying a first set of spectra as an anomalous spectra for an unknown material based on a plurality of spectra for one or more known particles in a particle spectra library; generating a plurality of synthetic spectra for the unknown material using the first set of spectra; creating a synthetic entry with the plurality of synthetic spectra for the unknown material in the particle spectra library; acquiring a second set of spectra for of the unknown material using the synthetic entry and spectra acquired from the one or more environmental surveillance sensors; validating the second set of spectra to be from the same source material as the first set of anomalous spectra; and replacing the synthetic entry with the second set of spectra for the unknown material in the particle spectra library.

### CROSS-REFERENCE TO RELATED APPLICATIONS

The present application claims the benefit of the filing date of U.S. Provisional Application Ser. No. 63/640,378, filed Apr. 30, 2024, the entire teachings of which application is hereby incorporated herein by reference.

### STATEMENT REGARDING FEDERALLY SPONSORED RESEARCH OR DEVELOPMENT

This invention was made with government support under contract number HR001119C0019 awarded by the Defense Advanced Research Projects Agency. The government has certain rights in the invention.

### TECHNICAL FIELD

The present disclosure relates to systems and methods for building adaptive libraries of environmental surveillance spectral data acquired via spectroscopy sensors using convolutional neural network (CNN) and generative adversarial network (GAN) technologies.

### BACKGROUND

Bioidentification systems provide a revolutionary solution to the biological defense landscape. They can effectively help tackle challenges from increased adversarial access to low-cost enabling technologies for production and deployment of weapons of mass destruction. A fully automated, networked, and adaptable bioidentification system can be deployed to detect illicit radioactive and nuclear materials, and alert authorities to chemical, biological, and explosives threats.

One critical objective is for the final system to be flexible enough to be deployed in a variety of environments while still maintaining its accuracy and reliability. Unfortunately, for biological detection and identification, this can be difficult due to the changing landscape of organisms not only with different environments, but also within the same environment over time. Moreover, many particle classification libraries, on which such identifications are normally relied, are built using controlled collections of specific organisms and measurement of their spectra. However, when a detection sensor is deployed to environments in which many new organisms are being encountered, it is not feasible to collect samples of every new organism and do a controlled library building run. Thus, detection and identification algorithms will have to be able to handle seasonal patterns of shifting abundances across known biological signatures, e.g., spectra, as well as be able to recognize when a new spectrum (i.e., an anomaly) is found.

The present disclosure provides a novel system that delivers rapid and autonomous identification of an ever-expanding list of airborne pathogens. Using an adaptive library building technology, the present system provides a near zero false positive rate of detection of both biological and non-biological particles for anomaly detection and signature collection for emerging threats. Thus, the system and method of the present disclosure could be used for adaptive library building to gradually incorporate newly encountered organisms, e.g., environmental contaminants or interferents, pollens, emerging pathogens, etc.

### BRIEF DESCRIPTION OF THE DRAWINGS

Reference should be made to the following detailed description which should be read in conjunction with the following figures, wherein like numerals represent like parts.

FIG. 1 is a functional block diagram illustrating a system to build an adaptive library for particles of organisms/species consistent with the present disclosure.

FIG. 1A is another functional block diagram illustrating an example system and method for the adaptive library building consistent with the present disclosure.

FIG. 2 illustrates another system and method for the adaptive library building consistent with the present disclosure.

FIG. 3 illustrates a flowchart for an example system and method for the adaptive library building consistent with the present disclosure.

FIG. 4 illustrates a flowchart for another example system and method for the adaptive library building consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

During spectral data collection in the environment, a bioidentification system identifies and catalogues anomalous spectra detected and acquired by environment surveillance sensors, e.g., Raman spectroscopy devices, a resource effective bioidentification system (REBS) or a next generation resource effective bioidentification system (REBS+) sensor, etc. The acquired spectra could be identified, for example, by observing the empirical distribution of posterior probabilities from a convolutional neural network (CNN) classifier based on the spectra from organisms in a particle spectra library comprising a plurality of spectra for one or more particles of known materials and then flagging any detected spectra whose classifier posteriors fall in low probability regions of those distributions.

Using an unsupervised clustering algorithm, the CNN classifier can split the anomalous spectra into groups. Clearly, the spectral features themselves would be key in performing this clustering, but other pieces of metadata (e.g., the locations at which the spectra were collected, the occurrences of related events that tie certain spectra to the existence of a new pathogen, etc.) may be incorporated in the algorithm.

For each cluster, or set, of anomalous spectra, a Generative Adversarial Network (GAN) algorithm can be used to compute the median spectrum and create a large number of realistic noise patterns around that median spectrum. By combining the median spectrum with the noise, the GAN algorithm then creates many library spectra, i.e., synthetic spectra for the anomalous/unknown organism, and inserts the synthetic spectra as a synthetic, or temporary entry to the particle spectra library.

Over time, as new spectra from the anomalous/unknown organism are encountered, these acquired spectra may be identified as high probability hits to the new synthetic library entry. In this process, the synthetic library entry will allow for the detection of the anomalous/unknown organism. With transfer learning, using more acquired spectra to retrain the final layers, the CNN algorithm can incorporate the new unknown class into the particle spectra library and replace the synthetic spectra with acquired spectra for the anomalous/unknown particle. Periodically, a review process that may involve human intervention may be necessary to update all layers of the CNN classifier/algorithm to allow for the discovery of new useful features as the library grows.

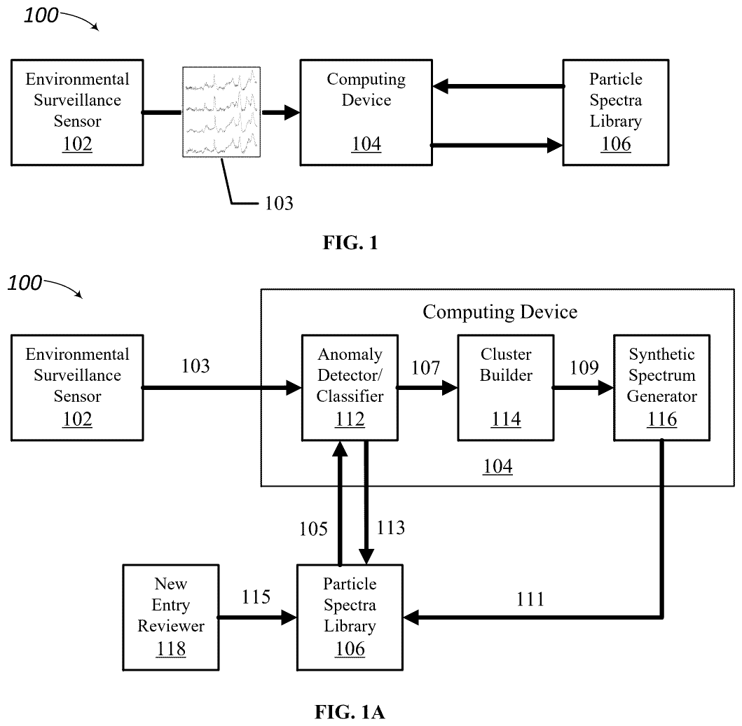

As illustrated in FIG. 1, a system 100 for adaptive library building generally comprises one or more environmental surveillance sensors 102, a computing device 104, and a particle spectra library 106. In some embodiments, the system 100 is directed to adaptive library building using generative adversarial networks (GANs) to gradually incorporate newly detected environmental particles of unknown organisms and/or species, e.g., environmental contaminants or interferents, pollens, emerging pathogens, bacteria, etc.

Specifically, the computing device 104 of the system 100 is coupled with the one or more environmental surveillance sensors 102. In some embodiments, the one or more environmental surveillance sensors 102 may include, but is not limited to, a Raman spectroscopy device, a REBS or REBS+sensor, and/or any other suitable device. Additionally, the one or more environmental surveillance sensors 102 are configured to acquire and feed to the computing device 104 a first set of spectra for a particle 103 in an environment, as shown in FIG. 1. Further, the one or more environmental surveillance sensors 102 may be communicatively coupled to the computing device 104 via a wired connection or wireless communication network.

Subsequently, the computing device 104 of the system 100 identifies the first set of spectra for a particle 103 as anomalous spectra for an unknown particle if the first set of spectra for a particle 103 does not match any of the plurality of spectra for known particles in the particle spectra library 106. In some embodiments, the particle spectra library 106 may reside on the computing device 104. In some other embodiments, the particle spectra library 106 may be external to the computing device 104. For example, the particle spectra library 106 may be stored in the cloud or on a remote server and be connected to the computing device 104 via a secure communication network. Additionally, the particle spectra library 106 may include a plurality of spectra for one or more particle of known species, and/or species labels, metadata, e.g., locations at which the spectra were collected, occurrences of related events that associate certain spectra to a specific pathogen, etc.

Additionally, the computing device 104 may generate a plurality of synthetic spectra for the unknown particle using the anomalous first set of spectra for a particle 103 and appends the resulted plurality of synthetic spectra to the particle spectra library 106 as a new entry. Such a new entry may be a temporary or surrogate entry, of which the spectra may ultimately be replaced with actual spectra acquired from the one or more environmental surveillance sensors 102.

Further, the computing device 104 may create a second set of spectra using spectra acquired from the one or more environmental surveillance sensors 102 when the second set of spectra is determined to have a high probability to be the same as the plurality of synthetic spectra of the unknown particle. Subsequently, the computing device 104 may validate the second set of spectra to be the same as the plurality of synthetic spectra and replace the synthetic entry with the real spectra from the second set of spectra for the unknown particle in the particle spectra library 106.

As illustrated in FIG. 1A, in some embodiments the computing device 104 may include an anomaly detector/classifier 112, a cluster builder 114, and a synthetic spectrum generator 116. Specifically, the anomaly detector/classifier 112 is configured to identify anomalous spectra 107 acquired from the one or more environmental surveillance sensors 102, e.g., the first set of spectra for a particle 103, as anomalous spectra associated with unknown particles of a plurality of unknown organisms when such spectra are not recognized among a plurality of spectra 105 in the particle spectra library 106. The anomalous spectra 107 may be fed to the cluster builder 114. The cluster builder 114 is configured to identify and group the anomalous spectra 107 for the same organism/species into a spectra cluster 109, which is then fed to the synthetic spectrum generator 116. In some embodiments, the anomaly detector/classifier 112 and/or the cluster builder 114 may use a convolutional neural network (CNN) algorithm. The CNN algorithm is configured to generally identify acquired spectra, e.g., the first set of spectra for a particle 103, as anomalous spectra for an unknown particle if the spectra are not in the particle spectra library 106. Additionally, the CNN algorithm may be used to determine if the spectra are from the same source/particle of a specific organism/species, either unknown or known based on the plurality of spectra in the particle spectra library 106.

The synthetic spectrum generator 116, in some embodiments, may include a generative adversarial network (GAN) algorithm configured to generate a plurality of synthetic spectra 111 for the unknown particle using the anomalous spectra cluster 109. The plurality of synthetic spectra 111 may be fictional, but realistic, examples that reflect the patterns in the acquired spectra, e.g., the first set of spectra for a particle 103, also called “training data.” Using the GAN algorithm, the synthetic spectrum generator 116 may start with random noise and use the noise to create realistic example spectra, (e.g., similar to the first set of spectra for a particle 103).

In other embodiments, the GAN algorithm may include a discriminator (e.g., discriminator algorithm) configured to optimize the resulting synthetic example spectra and generate the desired plurality of synthetic spectra 111 that is as realistic as possible, comparing with the acquired spectra, e.g., the first set of spectra for a particle 103. Specifically, the synthetic spectrum generator 116, via the GAN algorithm, mixes the resulting synthetic example spectra with the acquired spectra, e.g., the first set of spectra for a particle 103. The mixed spectra are then fed to the discriminator. The discriminator is configured to iteratively distinguish the synthetic spectra resulted at each iteration from the acquired spectra and determine if a pre-specified convergence is achieved, e.g., an optimal set of realistic synthetic spectra is generated. During each iteration, the GAN algorithm may use a loss function and a plurality of weights to produce example synthetic spectra/training data based on the production at the previous iteration. In some embodiments, since spectra from different organisms can be similar, the convergence may be critical to achieve the optimal set of realistic spectra comparing with acquired spectra, e.g., the first set of spectra, for an unknown organism.

In some other embodiments, the GAN algorithm may further comprise a variational autoencoder (VAE) algorithm configured to generate the desired set of synthetic spectra as realistic as possible. Specifically, the VAE algorithm may include at least an encoder, a variational generator, and a decoder. The encoder maps the first set of spectra for a particle 103 to a latent space as latent distributions. The variational generator transforms the latent distributions to achieve convergence, and the decoder converts the transformed latent distributions into the plurality of synthetic spectra. In some embodiments, the variational generator may iteratively generate new synthetic example spectra by sampling from the latent distributions and pushing the resulting latent distributions through the decoder to reconstruct new synthetic example spectra. Each input to the variational generator is also an output; at each iteration VAE algorithm may force encoder and decoder to work together to convert the input to the latent space and then back to the original space with as little reconstruction error as possible. This is similar to compressing and then decompressing an image and measuring how different the final image is from the original. The more well-behaved training objective of a VAE algorithm helps achieve convergence more efficiently than with a GAN algorithm.

As illustrated in FIG. 1A, in some embodiments, the synthetic spectrum generator 116 feeds the plurality of synthetic spectra 111 to the particle spectra library 106. The desired plurality of synthetic spectra 111 is then added to the particle spectra library 106 as a synthetic/temporary entry. Subsequently, the anomaly detector/classifier 112, via the CNN algorithm, creates a second set of spectra 113, using spectra acquired from the environmental surveillance sensor 102. The computing device 104 may validate the second set of spectra 113 to be the same as the plurality of synthetic spectra 111 of the unknown particle via, for example, the anomaly detector/classifier 112, or any other suitable algorithm, including, but not limited to, a spectra validator. Once the second set of spectra 113 is determined to be the same as the plurality of synthetic spectra 111 of the unknown particle, the computing device 104 replaces the plurality of the synthetic spectra 111 for the unknown particle, e.g., the synthetic/temporary entry, with the second set of spectra 113 in the particle spectra library 106.

Further, as illustrated in FIG. 1A, in some embodiments, the system 100 may include a new entry reviewer 118 that reviews the second set of spectra 113 for the unknown particle and assigns a species label and metadata to the unknown particle. Thus, the particle spectra library 106 is updated with a permanent entry for the unknown organism/species with actual spectra.

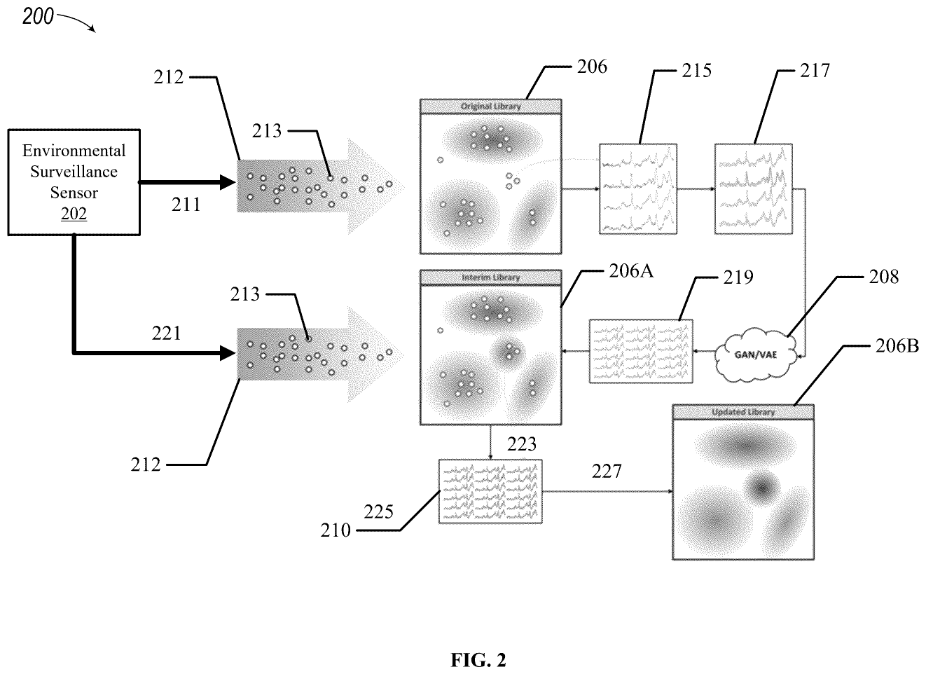

FIG. 2 illustrates a method 200 for adaptive library building. In some embodiments, the method 200 acquires one or more spectra 211 for an unknown particle 213 from a source material using one or more environmental surveillance sensors 202 via a computing device coupled thereof. The one or more spectra 211 are fed to and accumulated in an anomaly detector/classifier 212 to form a plurality of incoming spectra 215. Then, the anomaly detector/classifier 212 detects and classifies, from the plurality of incoming spectra 215, a first set of spectra 217 for the unknown particle 213. Additionally, the anomaly detector/classifier 212 determines if the first set of spectra 217 is anomalous spectra for the unknown particle 213 based on a plurality of spectra for one or more known particle/organism/species in a particle spectra library 206, e.g., the original library, wherein the first set of spectra 217 for the unknown particle 213 is not recognized. In some embodiments, the anomaly detector/classifier 212 may include the CNN algorithm as described above in detail.

As illustrated in FIG. 2, the method 200 feeds the first set of spectra 217 for the unknown particle 213 to a GAN/VAE synthetic spectrum generator 208. In some embodiments, the GAN/VAE synthetic spectrum generator 208 may include either a GAN algorithm or a VAE algorithm, or both (as described above) to generate a plurality of synthetic spectra 219 for the unknown particle 213 using the first set of spectra 217. Subsequently, the method 200 appends the plurality of synthetic spectra 219 for the unknown particle 213 to the particle spectra library 206A, e.g., an interim library, by adding a temporary or synthetic entry to the original library 206 as shown in FIG. 2.

As more spectra for the unknown particle 213, e.g., spectra 221, are acquired from the one or more environmental surveillance sensors 202, the anomaly detector/classifier 212 creates a second set of spectra 223 from the acquired spectra 221 for the unknown particle 213. Then the method 200 validates the second set of spectra 223 to be the same as the plurality of synthetic spectra 219 of the unknown particle 213 in the particle spectra library 206A, e.g., the interim library. In this step, the method 200 may use the anomaly detector/classifier 212, or any other suitable algorithm, e.g., a separate spectra validator (not shown). In some embodiments, the method 200 may feed the second set of spectra 221 to the GAN/VAE synthetic spectrum generator 208 to further optimize the synthetic spectra 219.

Once the number of spectra of the second set of spectra 223 reaches a pre-determined number, the method 200 may replace the plurality of the synthetic spectra for the unknown particle with the second set of spectra 223 in the particle spectra library 206B, e.g., an updated library comparing with the original library 206, as shown in FIG. 2.

Further, as illustrated in FIG. 2, in some embodiments, the method 200 may include a new entry reviewer 210. Specifically, the new entry reviewer 210 may be an algorithm or a manual review process that involves human intervention. For example, the new entry reviewer 210 may review the second set of spectra 223 for the unknown particle and assign a species label and metadata 225 to the unknown particle 213. The species label may be a unique identifier for the unknown species/organism, or a specific designator/code, etc. The metadata 225 may include a location at which any one spectrum of the second set of spectra 223 was collected, occurrences of related events under which the spectra were acquired, specific sensors used, etc. Thus, the method 200 updates the particle spectra library 206 with a permanent entry for the unknown organism/species with actual spectra and associated metadata 227.

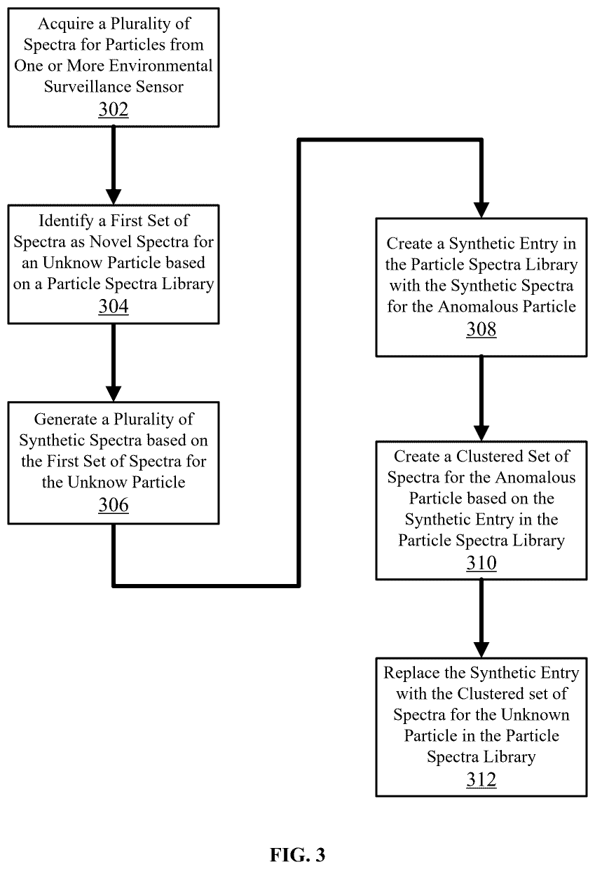

As illustrated in FIG. 3, in some embodiments, a method 300 for adaptive library building may start with acquiring a plurality of spectra for particles from one or more environmental surveillance sensor via a computing device coupled thereof 302. The process of the method 300 may include identifying a first set of spectra as anomalous spectra for an unknown particle based on a plurality of spectra for one or more known particle in a particle spectra library 304 and generating a plurality of synthetic spectra for the unknown particle using the first set of spectra 306. Additionally, the method 300 may include creating a synthetic entry with the plurality of synthetic spectra for the unknown particle in the particle spectra library 308. Additionally, the method 300 may include creating a second set of spectra for the unknown particle using spectra acquired from the one or more environmental surveillance sensor 310. Subsequently, the method 300 may validate the second set of spectra against the plurality of synthetic spectra of the unknown particle 312. Further, the method 300 may comprise replacing the synthetic entry with the second set of spectra for the unknown particle in the particle spectra library 314.

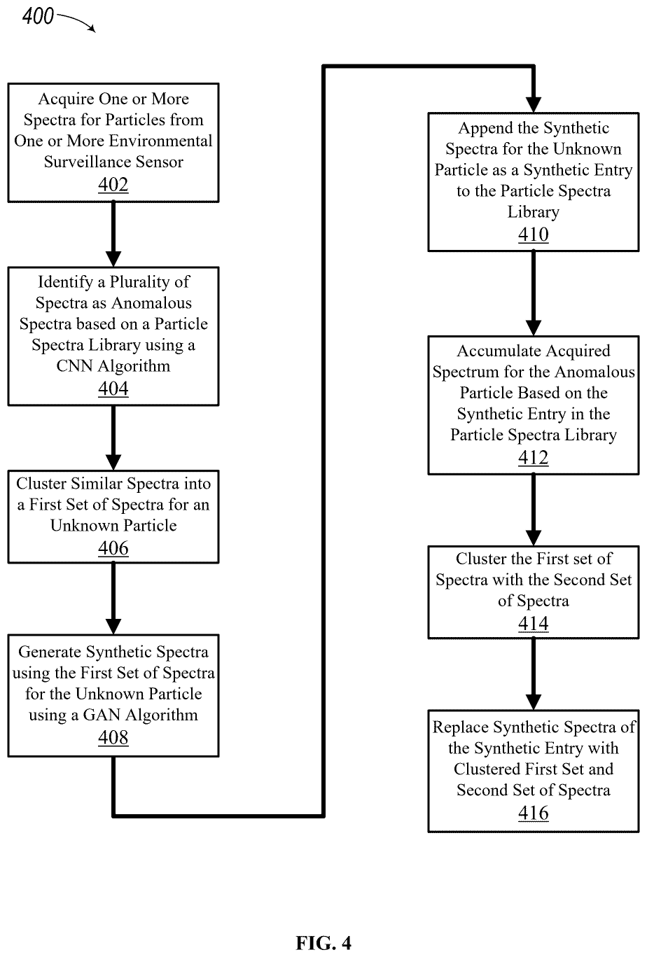

As illustrated in FIG. 4, in other embodiments, a method 400 for adaptive library building may include operations of acquiring one or more spectrum for particles from one or more environmental surveillance sensor via a computing device 402, and identifying a plurality of spectra as anomalous spectra based on a plurality of spectra for one or more known particles in a particle spectra library via a convolutional neural network (CNN) algorithm of the computing device 404. Additionally, the process of the method 400 may include clustering similar spectra of the plurality of spectra for an unknown particle into a first set of spectra 406, then generating a plurality of synthetic spectra for the unknown particle using the first set of spectra via a generative adversarial network (GAN) algorithm of the computing device 408. The process then appends the plurality of synthetic spectra for the unknown particle as a synthetic entry to the particle spectra library 410. With more incoming spectra acquired by the one or more environmental surveillance sensor and identified by the CNN algorithm for the unknown particle, the process may accumulate one or more acquired spectrum for the unknown particle when the CNN algorithm identifies the acquired spectrum to be the same as the plurality of synthetic spectra of the synthetic entry in the particle spectra library 412. Subsequently, the process creates a second set of spectra for the unknown particle from the accumulated spectra 414; and validates the second set of spectra against the plurality of synthetic spectra 416. Once validated, the process replaces the plurality of the synthetic spectra of the synthetic entry with the second set of spectra for the unknown particle in the particle library 418.

According to one aspect of the disclosure there is thus provided a method for adaptive library building, the method including: acquiring one or more spectra for particles from one or more environmental surveillance sensors via a computing device; identifying a first set of spectra as an anomalous spectra for an unknown particle based on a plurality of spectra for one or more known particles in a particle spectra library; generating a plurality of synthetic spectra for the unknown particle using the first set of spectra; creating a synthetic entry with the plurality of synthetic spectra for the unknown particle in the particle spectra library; creating a second set of spectra for of the unknown particle using spectra acquired from the one or more environmental surveillance sensors; validating the second set of spectra to be the same as the plurality of synthetic spectra; and replacing the synthetic entry with the second set of spectra for the unknown particle in the particle spectra library.

According to another aspect of the disclosure, there is thus provided a method for adaptive library building. The method includes: acquiring one or more spectra for particles from one or more environmental surveillance sensors via a computing device; identifying a plurality of spectra for an unknown particle from an anomalous plurality of spectra based on a particle spectra library using a convolutional neural network (CNN) algorithm of the computing device; clustering similar spectra of the plurality of spectra for an unknown particle into a first set of spectra; generating a plurality of synthetic spectra for the unknown particle using the first set of spectra using a generative adversarial network (GAN) algorithm of the computing device; appending the plurality of synthetic spectra for the unknown particle as a synthetic entry to the particle spectra library; accumulating acquired spectra for the unknown particle when the CNN algorithm identifies the acquired spectra to be the same as the plurality of synthetic spectra of the synthetic entry in the particle spectra library; creating a second set of spectra from the accumulated spectra for the unknown particle; validating the second set of spectra against the plurality of synthetic spectra; and replacing the plurality of the synthetic spectra of the synthetic entry with the second set of spectra in the particle spectra library.

According to yet another aspect of the disclosure, there is thus provided a system for adaptive library building. The system includes one or more environmental surveillance sensors configured to acquire a first set of spectra for a particle; a particle spectra library comprising a plurality of spectra for one or more particle of known particles; a computing device coupled with the one or more environmental surveillance sensors. The computing device is configured to: identify the first set of spectra as an anomalous spectra for an unknown particle based on the plurality of spectra in the particle spectra library; generate a plurality of synthetic spectra for the unknown particle using the anomalous spectra for an unknown particle; append the plurality of synthetic spectra for the unknown particle to the particle spectra library; create a second set of spectra for the unknown particle using spectra acquired from the one or more environmental surveillance sensors; validate the second set of spectra to be the same as the plurality of synthetic spectra; and replace the plurality of the synthetic spectra for the unknown particle with the second set of spectra in the particle spectra library.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art. Also, it may be appreciated that the phraseology and terminology used herein is for the purpose of description and should not be regarded as limiting as such may be understood by one of skill in the art. Throughout the present disclosure, like reference characters may indicate like structure throughout the several views, and such structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable, and not exclusive.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

What is claimed is:

1. A method for adaptive library building, the method comprising:
acquiring one or more spectra for particles from a source material using one or more environmental surveillance sensors via a computing device;
identifying a first set of spectra as an anomalous spectra for an unknown material based on a plurality of spectra for one or more known particles in a particle spectra library;
generating a plurality of synthetic spectra for the unknown material using the first set of spectra;
creating a synthetic entry with the plurality of synthetic spectra for the unknown material in the particle spectra library;
acquiring a second set of spectra for the unknown material using the synthetic entry and spectra acquired from the one or more environmental surveillance sensors;
validating the second set of spectra to be from a same source material as the first set of anomalous spectra; and
replacing the synthetic entry with the second set of spectra for the unknown material in the particle spectra library.

2. The method of claim 1, wherein the computing device further comprises at least one of a convolutional neural network (CNN) algorithm and a generative adversarial network (GAN) algorithm.

3. The method of claim 2, wherein the CNN algorithm is configured to determine if the first set of spectra are the anomalous spectra for the unknown material based on the plurality of spectra in the particle spectra library.

4. The method of claim 2, wherein the CNN algorithm is configured to determine if the second set of spectra is from the same source material as the first set of anomalous spectra of the unknown material.

5. The method of claim 2, wherein the GAN algorithm is configured to generate the plurality of synthetic spectra for the unknown material using the anomalous spectra.

6. The method of claim 2, further comprising:
computing a median spectrum of the first set of spectra;
creating a plurality of noise patterns around the median spectrum via the GAN algorithm; and
generating the plurality of synthetic spectra by combining the median spectrum with each of the plurality of noise patterns.

7. The method of claim 2, wherein generating the plurality of synthetic spectra for the unknown material using the first set of spectra further comprises:
generating a first set of synthetic example spectra based on the first set of spectra using the GAN algorithm;
generating a second set of synthetic example spectra by mixing the first set of synthetic example spectra and the first set of spectra; and wherein the GAN algorithm further comprises a discriminator algorithm configured to:
iteratively distinguish the second set of synthetic example spectra resulted at each iteration from an acquired spectra;
produce an optimal set of realistic synthetic spectra using the second set of synthetic example spectra at each iteration using a loss function and/or a plurality of weights based on production at a previous iteration; and
generate the plurality of synthetic spectra for the unknown material using the optimal set of realistic synthetic spectra if a pre-specified convergence is achieved.

8. The method of claim 2, wherein:
the GAN algorithm comprises a variational autoencoder (VAE) algorithm;
the VAE algorithm comprises at least an encoder, a variational generator, and a decoder;
the encoder maps the first set of spectra to a latent space as latent distributions;
the variational generator transforms the latent distributions to achieve convergence; and
the decoder converts the transformed latent distributions into the plurality of synthetic spectra.

9. The method of claim 1, further comprising:
reviewing the second set of spectra for the unknown material; and
assigning a label and metadata to the unknown material.

10. A method for adaptive library building, the method comprising:
acquiring one or more spectra for particles from one or more environmental surveillance sensors via a computing device;
identifying a plurality of spectra for an unknown material from an anomalous plurality of spectra based on a particle spectra library using a convolutional neural network (CNN) algorithm of the computing device;
clustering similar spectra of the plurality of spectra for an unknown material into a first set of spectra;
generating a plurality of synthetic spectra for the unknown material using the first set of spectra using a generative adversarial network (GAN) algorithm of the computing device;
appending the plurality of synthetic spectra for the unknown material as a synthetic entry to the particle spectra library;
accumulating acquired spectra for the unknown material when the CNN algorithm identifies the acquired spectra to be the same as the plurality of synthetic spectra of the synthetic entry in the particle spectra library;
creating a second set of spectra from the accumulated spectra for the unknown material;
validating the second set of spectra against the first set of anomalous spectra; and
replacing the plurality of the synthetic spectra of the synthetic entry with the second set of spectra in the particle spectra library.

11. A system for adaptive library building, the method comprising:
one or more environmental surveillance sensors configured to acquire a first set of spectra for particles in an environment;
a particle spectra library comprising a plurality of spectra for one or more particles of known materials;
a computing device coupled with the one or more environmental surveillance sensors; and wherein the computing device is configured to:
identify the first set of spectra from a source material as an anomalous spectra for an unknown material based on the plurality of spectra in the particle spectra library;
generate a plurality of synthetic spectra for the unknown material using the anomalous spectra for an unknown particle;
append the plurality of synthetic spectra for the unknown material to the particle spectra library;
create a second set of spectra for the unknown material using spectra acquired from the one or more environmental surveillance sensors;
validate the second set of spectra to be from a same source material as the first set of anomalous spectra; and
replace the plurality of the synthetic spectra for the unknown material with the second set of spectra in the particle spectra library.

12. The system of claim 11, wherein the computing device further comprises at least one of a convolutional neural network (CNN) algorithm and a generative adversarial network (GAN) algorithm.

13. The system of claim 12, wherein the CNN algorithm is configured to identify the first set of spectra as anomalous spectra for an unknown material based on the plurality of spectra in the particle spectra library.

14. The system of claim 12, wherein the CNN algorithm is configured to determine if the second set of spectra is the same as the plurality of synthetic spectra of the unknown material.

15. The system of claim 12, wherein the GAN algorithm is configured to generate the plurality of synthetic spectra for the unknown material using an anomalous spectra.

16. The system of claim 12, wherein generate the plurality of synthetic spectra for the unknown material using the anomalous spectra for an unknown material further comprises:
generating a first set of synthetic example spectra based on the first set of spectra using the GAN algorithm;
generating a second set of synthetic example spectra by mixing the first set of synthetic example spectra and the first set of spectra; and wherein the GAN algorithm comprises a discriminator algorithm configured to:
iteratively distinguish the second set of synthetic example spectra resulted at each iteration from acquired spectra;
produce an optimal set of realistic synthetic spectra using the second set of synthetic example spectra at each iteration using a loss function and/or a plurality of weights based on production at a previous iteration; and
generate the plurality of synthetic spectra for the unknown material using the optimal set of realistic synthetic spectra if a pre-specified convergence is achieved.

17. The system of claim 12, wherein:
the GAN algorithm comprises a variational autoencoder (VAE) algorithm;
the VAE algorithm comprises at least an encoder, a variational generator, and a decoder;
the encoder maps the first set of spectra to a latent space as latent distributions;
the variational generator transforms the latent distributions to achieve convergence; and
the decoder converts the transformed latent distributions into the plurality of synthetic spectra.

18. The system of claim 11, wherein the computing device is further configured to:
review the second set of spectra for the unknown material; and
assign a label and metadata to the unknown material.

19. The system of claim 11, wherein the one or more environmental surveillance sensors comprises a Raman spectroscopy device.

20. The system of claim 11, wherein the one or more environmental surveillance sensors comprises a resource effective bioidentification system (REBS) or a next generation resource effective bioidentification system (REBS+) sensor.
